(19) United States
(12) Patent Application Publication
(10) Pub. No.: US 2007/0286696 A1
(43) Pub. Date: Dec. 13, 2007

(54) Tie down system for recreational vehicles

(76) Inventor: Vincent P. Hackenmueller, Elk River, MN (US)

Correspondence Address: LITMAN LAW OFFICES, LTD., P.O. BOX 15035, CRYSTAL CITY STATION, ARLINGTON, VA, 22215, US

(21) Appl. No.: 11/797,170

(22) Filed: May 1, 2007

Related U.S. Application Data
(60) Provisional application No. 60/813,005, filed on Jun. 13, 2006.

(51) Int. Cl. B60P 3/073

(52) U.S. Cl. 410/8

(57) ABSTRACT

The tie down system for recreational vehicles is designed for securing a recreational vehicle to a support surface, such as a standard hitched trailer or the like. The system includes a horizontal base, at least one support bar extending upward therefrom, and at least one clamping member. The horizontal base is adapted for connecting the tie down system to the support surface. The one or more support bars are provided for engaging the recreational vehicle and each clamping member is operatively engageable with one of the support bars and is operable between an unlocked position and a locked position for securing the recreational vehicle to the support surface. A control rod linkage to a rear hitch tie down may also be provided in the system.

### CROSS-REFERENCE TO RELATED APPLICATION

This application claims the benefit of U.S. Provisional Patent Application Ser. No. 60/813,005, filed Jun. 13, 2006.

### BACKGROUND OF THE INVENTION

1. Field of the Invention

The present invention relates to securing devices, and more specifically to a tie down system for securing a recreational vehicle to a support surface.

2. Description of the Related Art

All different types of recreational vehicles exist, such as snowmobiles, motorcycles, all terrain vehicles, jet skis, etc. Of these vehicles, there are all different sizes and configurations. Using such a vehicle often requires transporting to a particular place, e.g., a lake, an off road track, etc. The most common mode of transportation is a flat surface such as a trailer hitched behind an automobile or the like. Accordingly, there is a need for securing the recreational vehicle or appliance to the trailer when it is in transit on the trailer. Thus a tie down system for recreational vehicles solving the aforementioned problems is desired.

### SUMMARY OF THE INVENTION

The tie down system for recreational vehicles comprises components designed for securing a recreational vehicle to a support surface and includes a horizontal base, at least one longitudinally extending support bar, and at least one clamping member. The horizontal base is adapted for connecting the tie down system to the support surface. The one or more longitudinally extending support bars are provided for engaging the recreational vehicle and each clamping member is operatively engageable with one of the support bars for securing the recreational vehicle to the support surface.

These and other features of the present invention will become readily apparent upon further review of the following specification and drawings.

### BRIEF DESCRIPTION OF THE DRAWINGS

FIG. 1A is an environmental, perspective view of a first embodiment of the tie down system, according to the present invention.

FIG. 1B is an environmental, perspective view of a second embodiment of the tie down system, according to the present invention.

FIG. 1C is an environmental, perspective view of a third embodiment of the tie down system, according to the present invention.

FIG. 1D is an environmental, perspective view of the clamp engaging a tie down bar of an ATV, according to the present invention.

FIG. 2A is a perspective view the third embodiment of a tie down system, according to the present invention.

FIG. 2B is a perspective view of a reconfigurable version of the third embodiment of the tie down system, according to the present invention.

FIG. 3A is a perspective view of the 1A embodiment of the tie down system, according to the present invention.

FIG. 3B is a perspective view of the 1B embodiment of the tie down system, according to the present invention.

FIG. 3C is a perspective view of the 1B embodiment of the tie down system in a drive over configuration, according to the present invention.

FIG. 4A is a partial cutaway, perspective view of the clamp assembly of the tie down system in an unlocked position, according to the present invention.

FIG. 4B is a partial cutaway, perspective view of the clamp assembly of the tie down system in a locked position, according to the present invention.

FIG. 5A is a side, perspective view of the tie down assembly showing operational linkage to a rear folding hitch strap in a stored configuration, according to the present invention.

FIG. 5B is a side, perspective view of the tie down assembly showing operational linkage to a rear folding hitch strap in a ready configuration, according to the present invention.

FIG. 6A is a side perspective view of the hitch strap in a lock ready extended position over the hitch of an ATV, according to the present invention.

FIG. 6B is a side perspective view of the hitch strap in a locked r extended position over the hitch of an ATV, according to the present invention.

Similar reference characters denote corresponding features consistently throughout the attached drawings.

### DETAILED DESCRIPTION OF THE PREFERRED EMBODIMENTS

The present invention is a tie down system for recreational vehicles, having several embodiments to address a user's preference for fixed, reconfigurable, and dual (front and rear) systems.

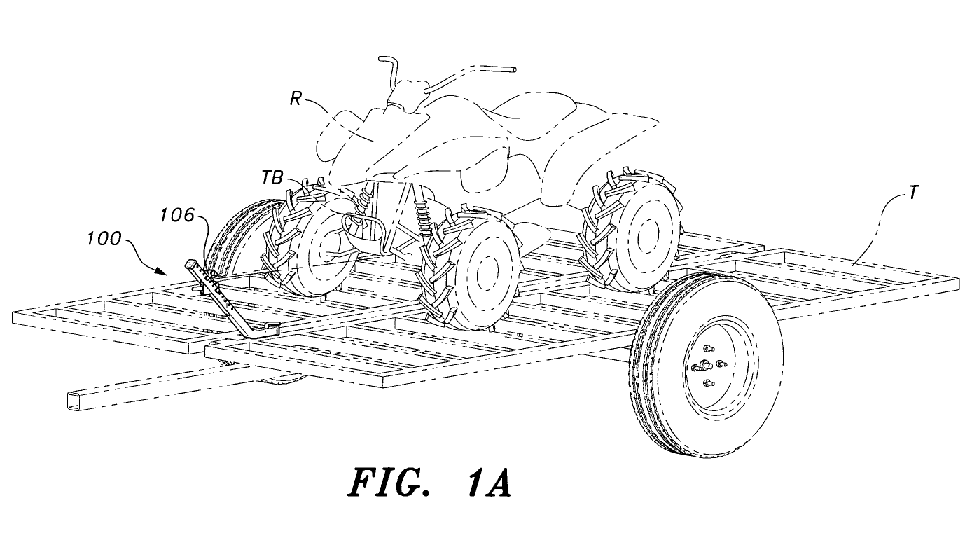

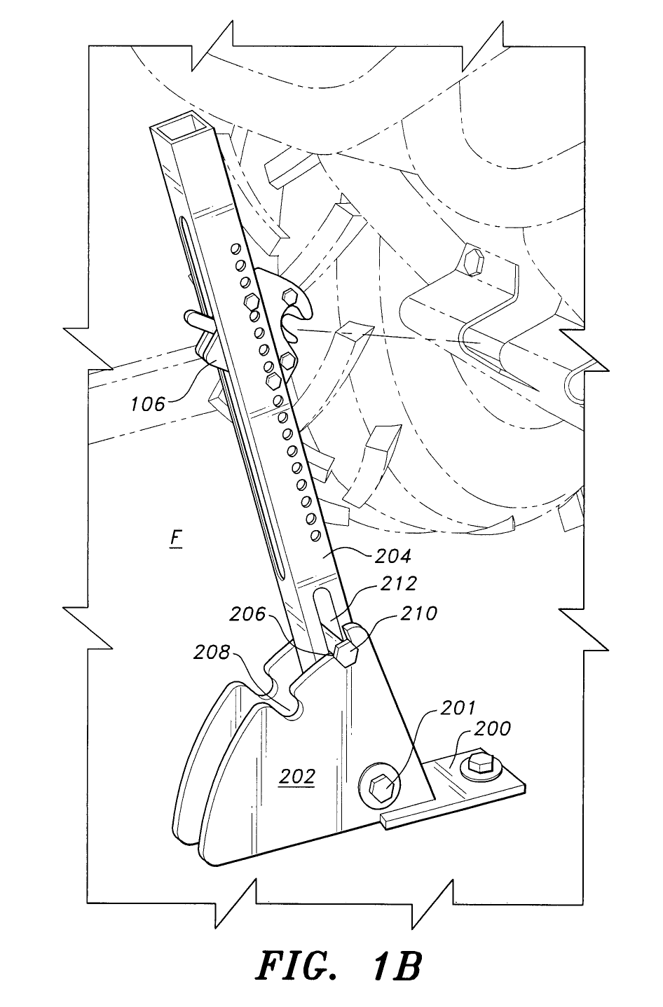

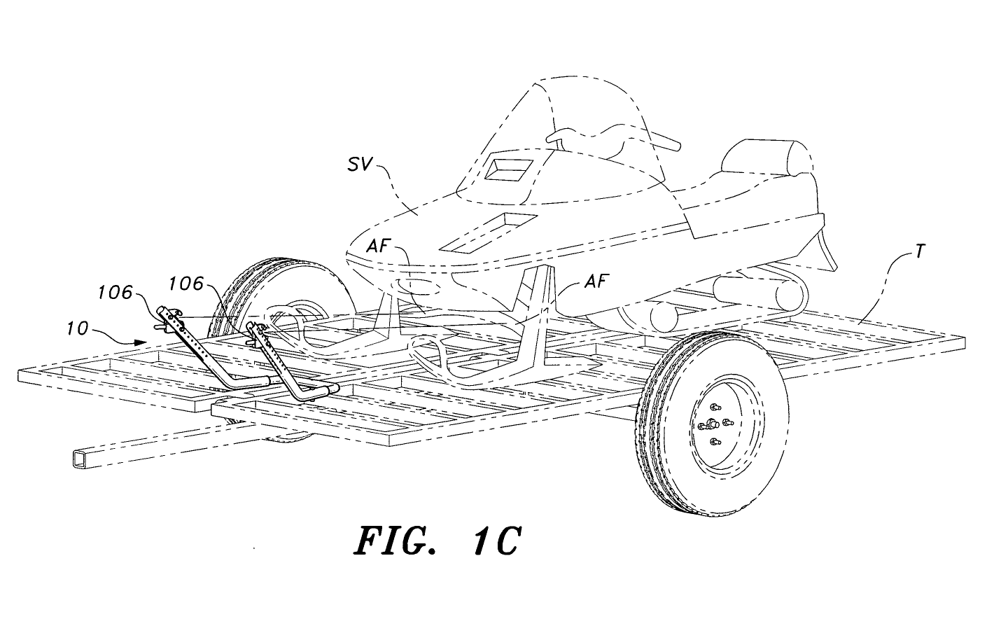

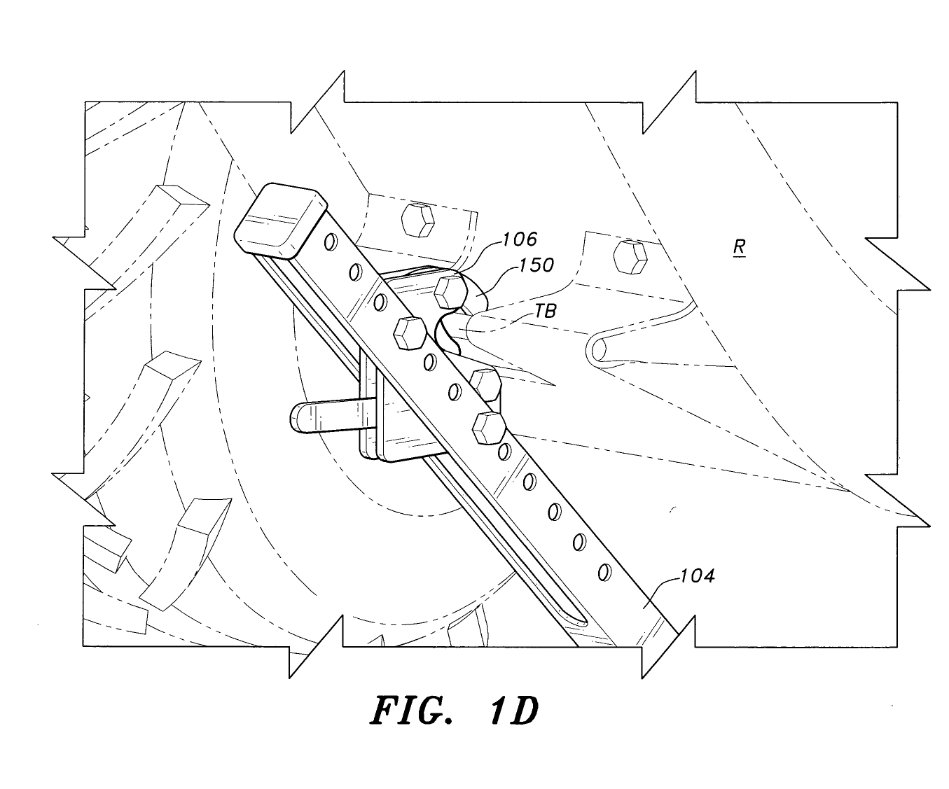

Referring to FIG. 1A, tie down system 100 is designed for securing a recreational vehicle R to a support surface of a standard flatbed F or the like. Recreational vehicle R can be a snowmobile, motorcycle, all terrain vehicle, jet ski, or any such vehicle that has a horizontal tie-down bar TB, an accessible horizontal frame component, an accessible horizontal suspension component, or the like. A portion of the body of the recreational vehicle R in a front section of the desired recreational vehicle R, engages tie down system 100 by coming in contact with a clamp assembly 106 of the tie down system 100 to secure the recreational vehicle R to the support surface of flatbed F or trailer T.

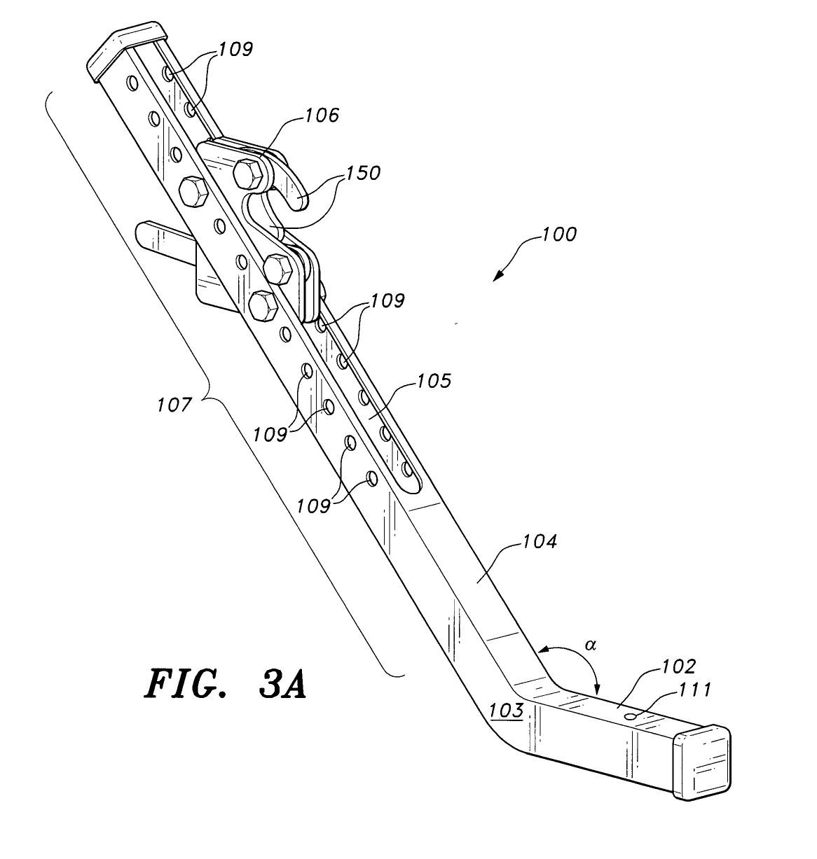

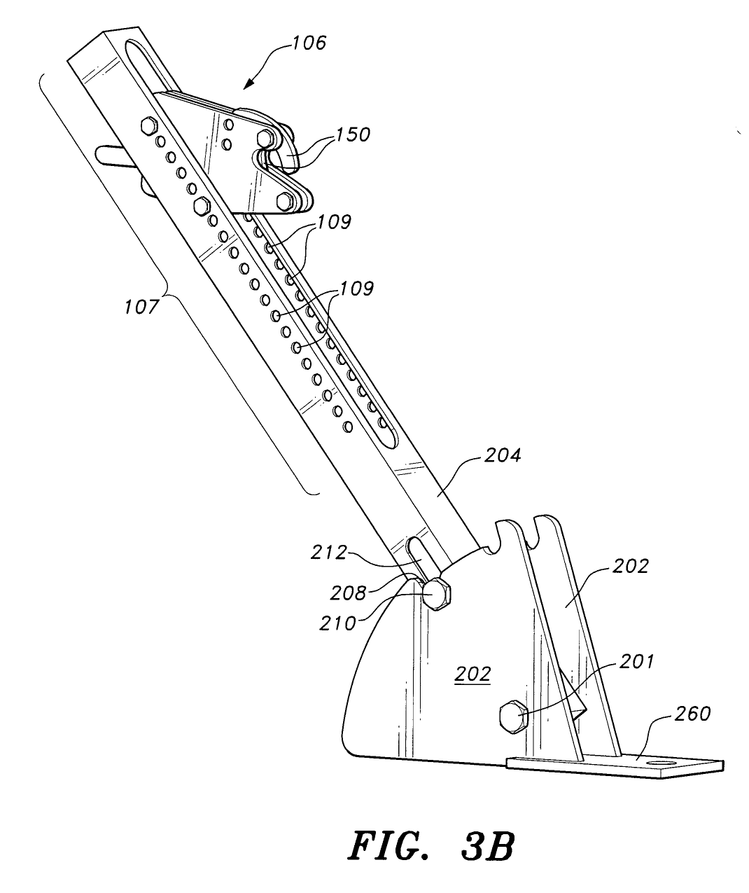

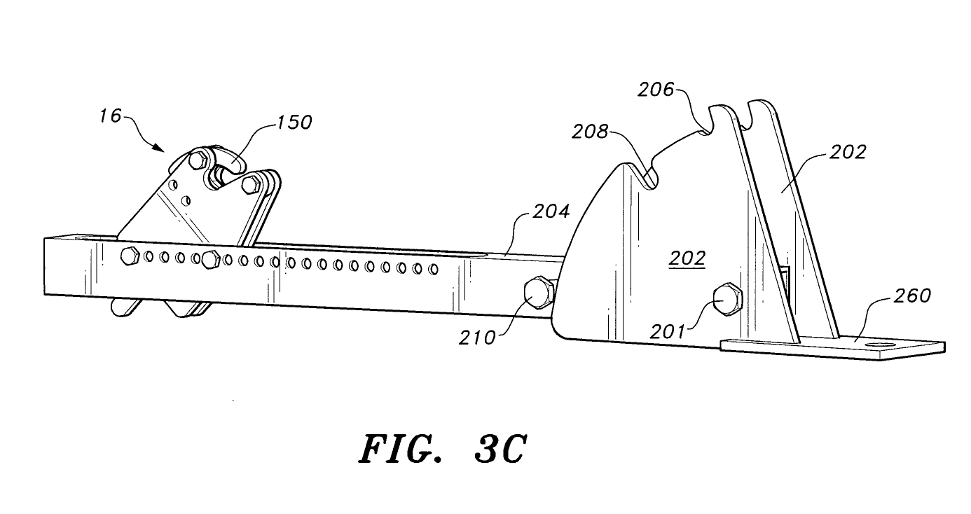

FIGS. 1A and 3A show a first embodiment of tie down system 100 which comprises a single support member of preferably unitary construction 103 having a horizontal base portion 102 and a substantially elongated portion 104 that extends upward from the base 102 at an angle α that is preferably greater than or equal to 90° and less than 180°. The support member elongated portion 104 has a longitudinally extending open channel 105 bounded by opposing lateral sidewalls 107. A plurality of axially aligned through bores 109 are disposed in the sidewalls 107 from a lower region of the elongated portion 104 to an upper region of the elongated portion 104. A clamp 106 is height adjustably disposed through the open channel 105 and is retained in a user selectable height position within the channel 105 by placement of bolts or locking pins 1 8 through the axially aligned bores 109 and the clamp housing 16c of the clamp 106. Horizontal base portion 102 is adapted for connecting tie down system 100 to the desired support surface and, to that end, may be provided with one or more mounting through bores 111 for securing horizontal base 102 to the desired support surface with the use of a series of fasteners. Elongated portion 104 extends from horizontal base 102 and acts as a support bar for engaging the desired recreational vehicle, such as vehicle R. Elongated portion 104 is provided with a clamp 106 that engages a portion of the body, preferably the horizontal tie-down bar TB, which is usually provided in a front section of the desired recreational vehicle R and is used for securing the desired recreational vehicle to the desired support surface. As shown in FIG. 1D, elongated portion 104 and clamp 106 are configured such that clamp 106 is operatively engageable with the elongated portion 104 in a manner that allows the height of the clamp 106 to be adjustable, so that the bifurcated claws 150 of clamp 106 can latch on to a variety of different sized and shaped recreational vehicles such as vehicle R having tie-down bar TB.

As shown in FIGS. 1B, 3B-3C, yet another embodiment of the system 106 has an upwardly extending elongated support bar 204 that is permitted to swing into a substantially upright vehicle loading resting angular position, a more obtuse angled vehicle locking resting angular position, and a horizontal, low profile “drive over” resting angular position. The base which comprises parallel aligned upright arcuate plates 202 joined together by a flate rectangular base plate 200 provides first 206 and second 208 detents to set the bar positions to load and locked settings respectively. The support bar 204 is pivotally attached to the base via bar pivot pin and fastener 201. A longitudinally slidable lock pin 210 is disposed in a slot 212 on the bar 204 and can engage first detent 206 when a user slides the lock pin 210 in a direction that clears the second detent 208, while the user pushes the bar towards the load position. The user can then release the lock pin 210 which drops into the first detent 206, securing the bar 204 into the load configuration. It should be noted that the first detent 206 has a shallow trailing edge, allowing a nudging of the bar 204 in a direction towards the lock detent 208 to dislodge the lock pin 210 and bar 204 from the load configuration. The second detent has a deep trailing edge capable of securing the bar 204 via lock pin 210 in the lock configuration.

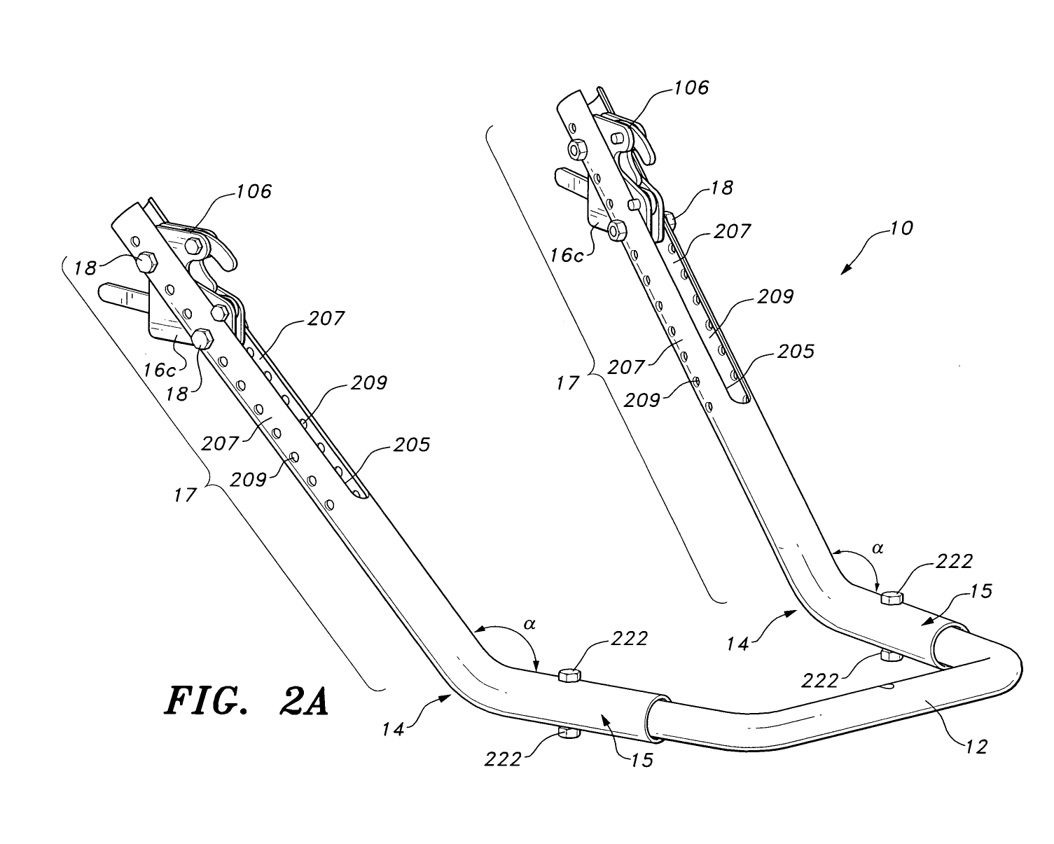

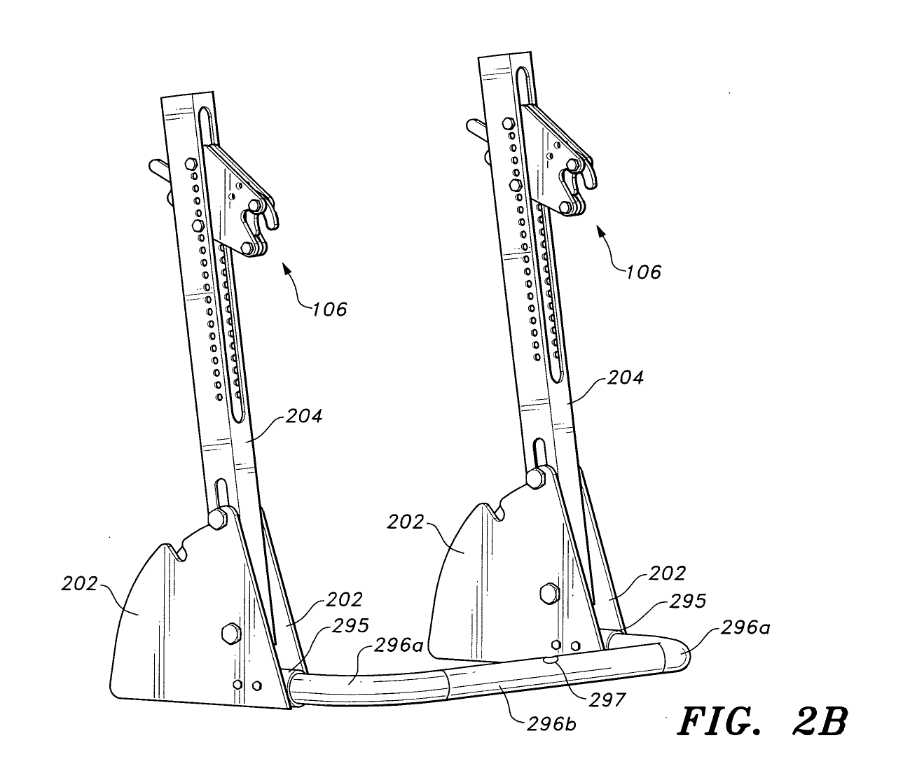

As shown in FIGS. 1C and 2A, a dual member embodiment tie down system 10 has a tubular U shaped member capable of functioning as a horizontal base 12 from which dual support bars 14 extend away from and upward. Each of support bars 14 has a horizontal portion 15 that can fit over an end of U tube 12 and is attached to the U tube 12 via fasteners such as bolt and nut assembly 222. For each support bar 14, a substantially elongated portion 17 extends upward from the horizontal portion 15 at an angle α that is preferably greater than or equal to 90° and less than 180°. Each support member elongated portion 17 has a longitudinally extending open channel 205 bounded by opposing lateral sidewalls 207. A plurality of axially aligned through bores 209 are disposed in the sidewalls 207 from a lower region of the elongated portion 17 to an upper region of the elongated portion 17. For each support member 14, a clamp assembly 106 is height adjustably disposed through the open channel 205 and is retained in a user selectable height position within the channel 205 by placement of bolts or locking pins 18 through the axially aligned bores 209 and the housing 16c of the clamp 106. Horizontal base 12 is adapted for connecting tie down system 10 to the desired support surface and, to that end, may be provided with one or more apertures for securing horizontal base 12 to the desired support surface with the use of a series of fasteners. Elongated members 14 extend upward from horizontal base 12 and act as support bars for engaging the desired recreational vehicle, such as vehicle R. Upwardly extending elongated portions 17 are provided with clamps 106 that engage laterally opposing portions, such as, e.g., left and right A frame suspension members AF on snowmobile SV, or the like, of the body provided in a front section of the desired recreational vehicle and are used for securing the desired recreational vehicle to the desired support surface. Upwardly extending elongated portions 17 and clamps 106 are configured such that clamps 106 are operatively engageable with the elongated portions 17 in a manner that allows the height of the clamps 106 to be adjustable, allowing device 10 to be usable on a variety of different sized and shaped recreational vehicles having a tie-down bar TB.

As shown in FIG. 2B, the dual system can also be adapted to provide reconfigurable support bars 204 having “load”, “locked”, and “drive over” positions similar to the configurations shown in FIGS. 1B, 3B, and 3C. Base members have the two detent system similar to the single unit shown in FIG. 1B. Base joining members 295 are disposed inside respective base plate pairs 202. Arcuate extension members 296a are attached to the respective joining members 295. Laterally extending member 296b connects to both extension members 296a to form a U shaped attachment member that can be bolted or otherwise affixed to a flatbed F, pickup bed, trailer bed, or the like, via mounting bore 297.

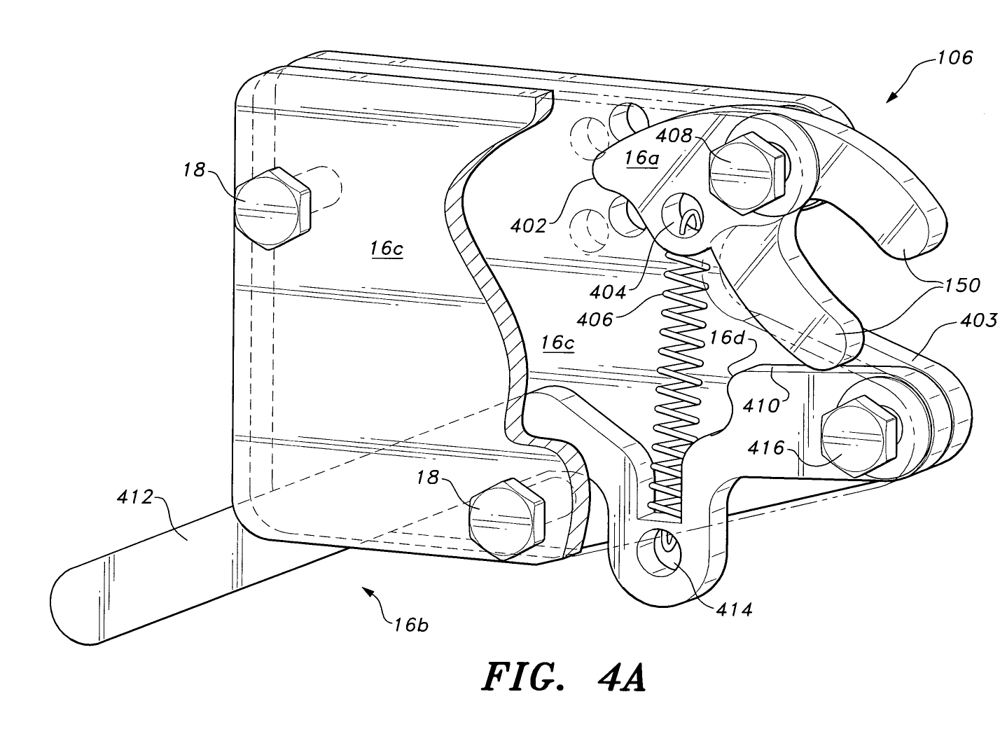

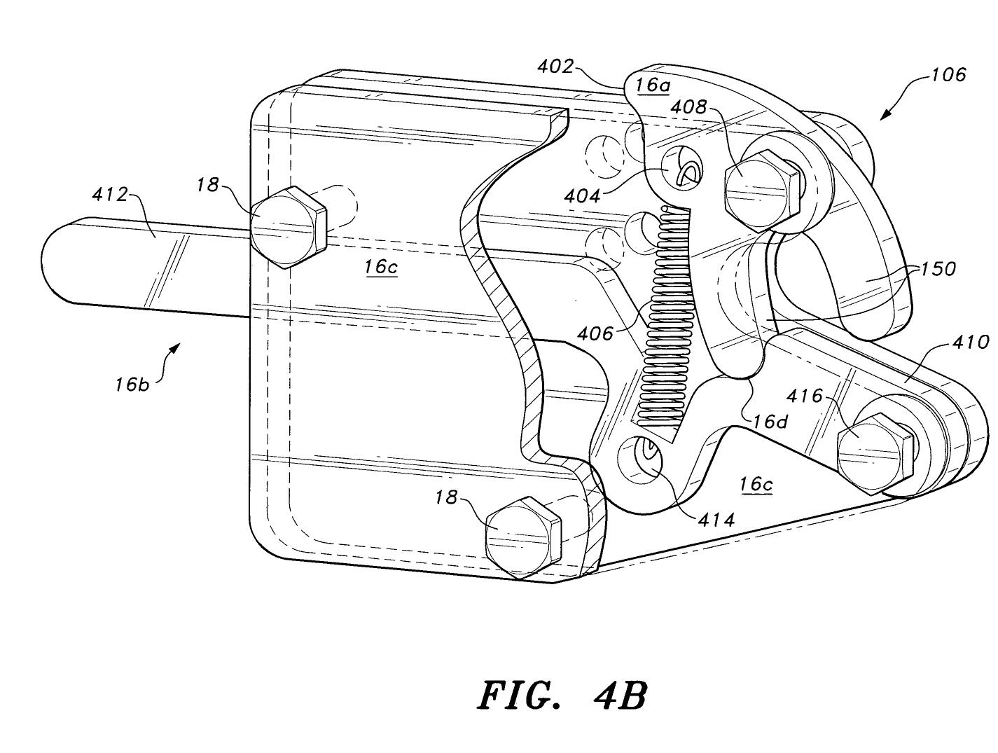

FIGS. 4A-4B show more detailed views of clamp 106. Clamp 106 includes clamp housing members comprising two parallelly aligned plates 16c, each having a recessed anterior portion 403 through which a latching member 16a is allowed to protrude. The generally arcuate Y shaped latching member 16a having anterior bifurcated claws 150, and posterior clamp stop boss 402 is rotatably attached between the clamp housing members 16c. The clamp stop boss 402 is provided to limit angular displacement of the claws 150. A spring attachment bore 404 is provided on the latching member 16a so that the latching member 16a may be normally biased in the open position by spring 406. Latching member 16a is rotatably attached to the housing between housing members 16c via pivot fastener 408.

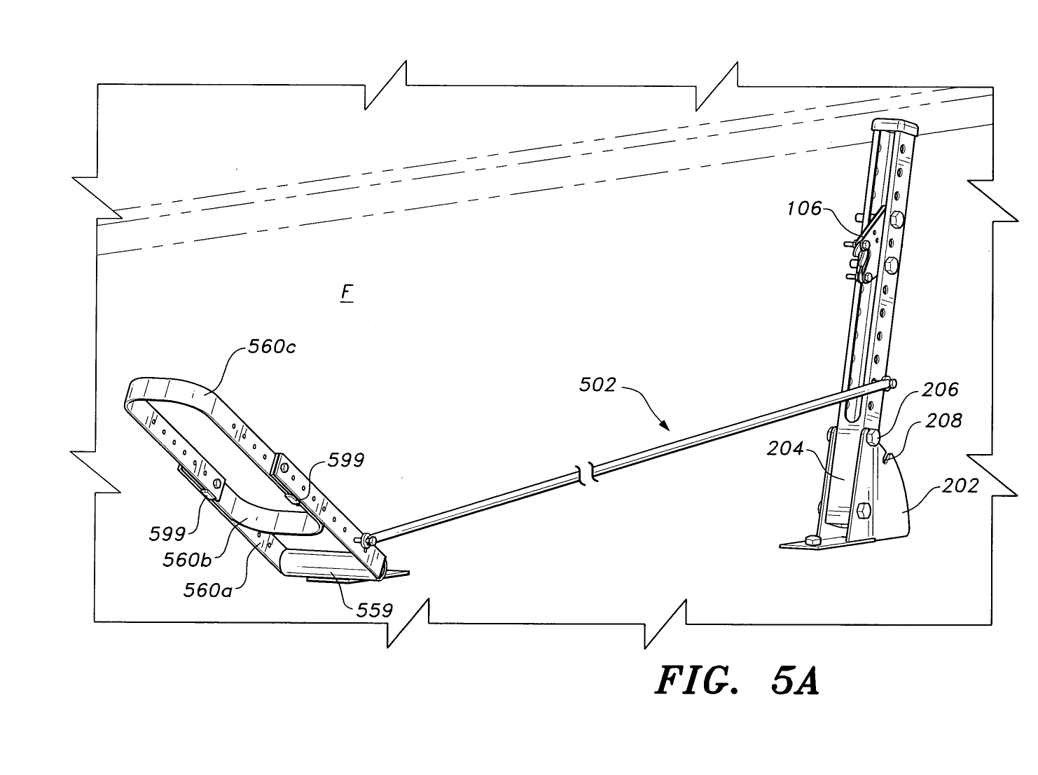

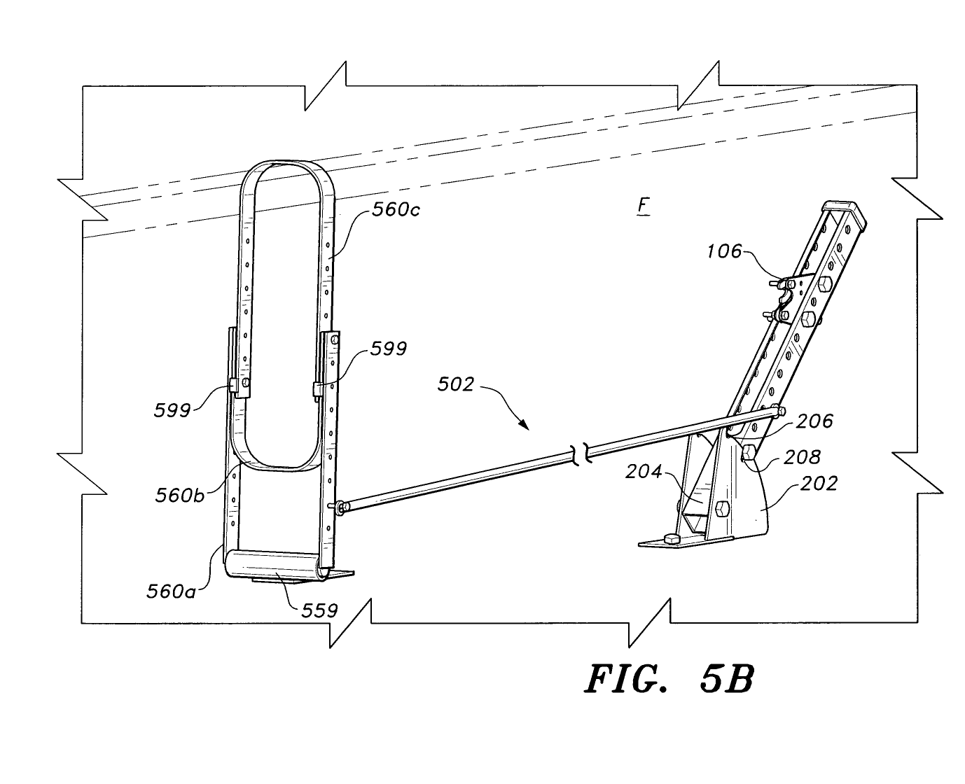

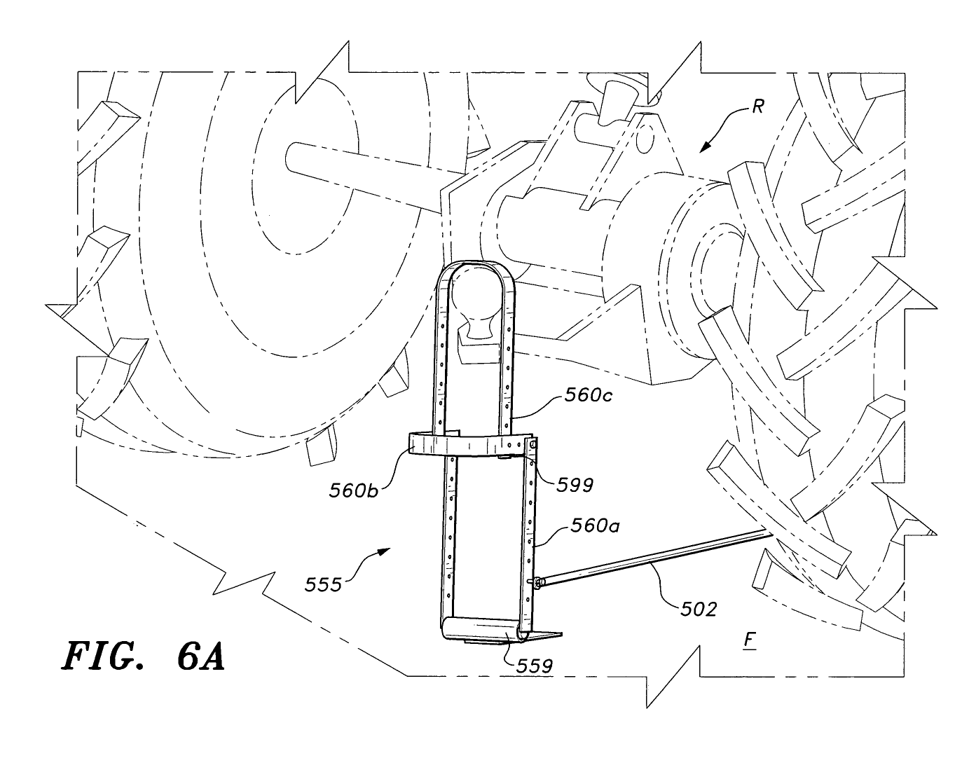

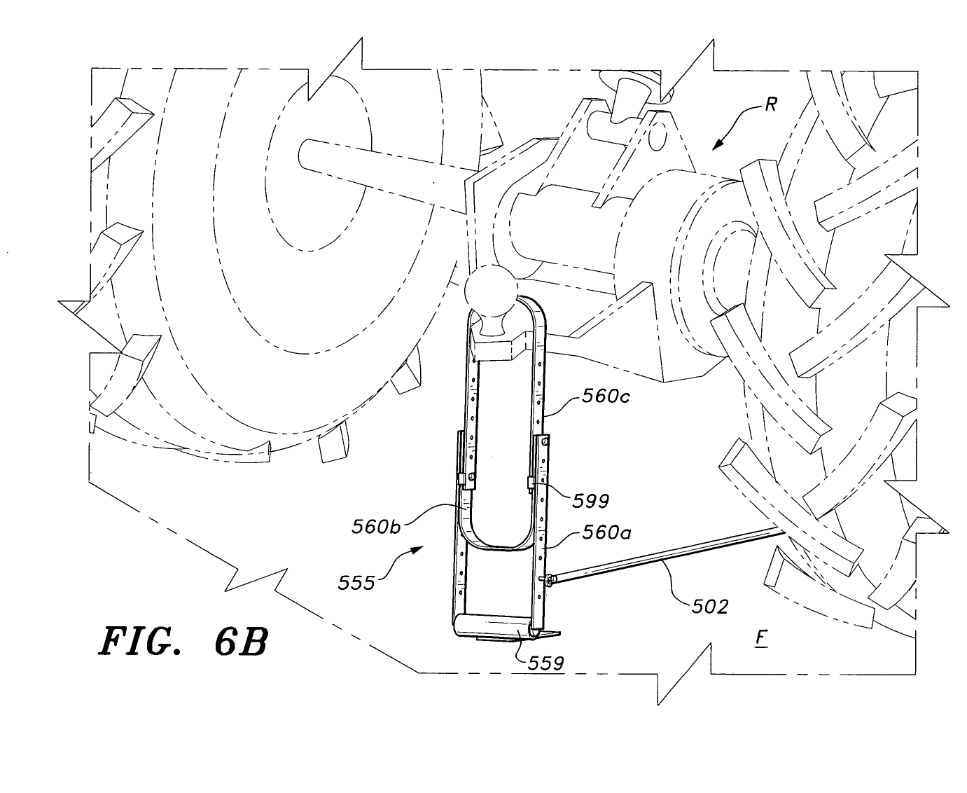

Additionally, release lever 16b has an anterior latch unlocking ledge 410, and a posterior lever handle portion 412. Disposed between the latch unlock ledge 410 and the posterior lever handle portion 412 is a latch locking detent 16d. Disposed on release lever 16b between the latch locking detent and the posterior lever handle portion is a recessed area that provides a spring bias attachment through bore 414. Anterior portion of release lever 16b is pivotally attached via pivot fastener 416 to the housing between housing members 16c. Spring 406 connected between spring bias attachment points 404 and 414 keep the latching member 16a in an open position with the lower of claws 150 resting on the latch unlock ledge 410 of the release lever assembly 16b. As the portion of the recreational vehicle to be held/tied down engages the latch claws 150, the lower latch claw slides along the unlocking ledge 410 towards the latch locking detent 16d until the claw 150 clears the unlocking ledge 410. The spring bias in the release lever 16b causes the detent 16d to engage and securely lock the clamp claws 150 around the portion of the vehicle caught between the claws 150 as the lower of the claws 150 clears the unlocking ledge 410 (See FIGS. 5 and 6). To release the clamp assembly 106, a user pushes down on the handle of the release lever 16b. This causes the lower of the claws 150 to clear the detent 16d allowing the spring biased claws 150 to rotate into the unlock position. The lever 16b can then be allowed to return to its resting position wherein the unlocking ledge 410 supports the lower of the claws 150.

Clamp assembly 106 is also provided with a series of fasteners 18 for connecting the clamp assembly 106 at an adjustable position inside the channel 105 of the support member 103.

As shown in FIGS. 5A-5B, and 6A-6B, all of the aforementioned reconfigurable tie down systems may be pivotally attached via a control rod 502 to a rear hitch tie down assembly 555 that is mounted to the rear of the base connected to support member 103, or the like. Rear hitch tie down assembly 555 is comprised of interconnected, pivoting U shaped members 560a, 560b, and 560c that can be pivoted into an extended position, placed over a hitch ball of a vehicle, and then pivoted into a locked position on the hitch ball. U shaped member 560b has at least one stop boss, i.e., tab 599 to prevent it from folding back beyond parallel alignment with member 560a as a user pivot latches the assembly over the ball hitch. The assembly 555 is pivotally attached to the trailer or flatbed via attachment tube 559 which is secured to the flatbed F via fasteners, or the like. Horizontal portion of member 560a is a cylindrical piece which is capable of rotating inside cylindrical tube 559. When a support bar such as reconfigurable support bar 204 is in the configuration provided by the first detent 206, i.e., the “load” configuration, and linked with the rear hitch tie down 555 via control rod 502, the rear hitch tie down is in a stowed configuration disposed at a shallow angular displacement from the flat bed surface F so that an ATV such as vehicle R can pass over the rear hitch tie down. As the vehicle bumps the front support the support pivots into the “locked position” at second detent 208. The resultant horizontal displacement of the control rod 555 places the rear hitch tie down in a “ready configuration that is approximately 90° from the flat bed surface. As shown in FIGS. 6A-6B, subsequently a user can place the upper portion of the rear hitch tie down over the hitch and manually clamp the tie down to secure the rear hitch of the vehicle.

It is to be understood that the present invention is not limited to the embodiments described above, but encompasses any and all embodiments within the scope of the following claims.

I claim:

1. A tie down system for securing a recreational vehicle to a support surface, comprising:
at least one base attachable to the support surface;
at least one support bar extending upward from the base, the at least one support bar having an adjustably positioned clamp; and
the clamp being operably engageable with the recreational vehicle for securing the recreational vehicle to the support surface.

2. The tie down system according to claim 1, wherein the base and support bar are of unitary construction, the support bar extending upward from the base at an angle between 90° and 180°.

3. The tie down system according to claim 1, further comprising:
a longitudinally extending open channel being disposed within the support bar;
a plurality of axially aligned through bores being disposed on opposing lateral sidewalls bounding the open channel; and
wherein the adjustably positioned clamp can be placed in alignment with a desired set of the through bores and fastened thereto with fasteners to thereby facilitate the adjustably positioned of a location on the support bar.

4. The tie down system according to claim 1, further comprising:
the base being a U shaped member; and
the at least one support bar comprising two support bars, each support bar extending away and upward from a respective end of the U shaped member.

5. The tie down system according to claim 1, further comprising:
the at least one support bar being pivotally attached to the at least one base and having at least one resting angular position to facilitate loading and locking of the vehicle to the clamp.

6. The tie down system according to claim 5, further comprising:
a resting angular position of the support bar that provides a low profile of the support bar wherein sufficient clearance is allowed so that the vehicle can be driven over the support bar.

7. The tie down system according to claim 5, further comprising:
a pair of support bars parallely separated a predetermined distance from each other, wherein a respective clamp on a respective support bar can engage a vehicle at a respective separate location on the vehicle.

8. The tie down system according to claim 7, further comprising:
base members being separated the predetermined distance by a U shaped tube having respective ends rigidly attached to a respective base member;
the U shaped tube having at least one through bore through which a fastener can securely attach the assembly to the support surface.

9. The tie down system according to claim 5, wherein the at least one base comprises:
two parallely aligned upright arcuate plates, each of the plates having a first detent and a second detent, first detents on the two plates being laterally aligned with each other, second detents on the two plates being laterally aligned with each other;
the support bar having a slot;
the slot accommodating a support bar locking pin that can engage first and second detents to cause the support bar to rest at a corresponding said resting angular position;
the first detent having a shallow trailing edge profile and corresponding to a substantially upright loading position of the support bar; the second detent having a deep trailing edge profile and corresponding to a more angular locking position of the support bar; and
wherein as the vehicle comes in contact with the clamp the bar is nudged out of the load position and pivots until the pin slides into the lock position thus providing sufficient resistance to the vehicle motion to positively lock the clamp to the vehicle.

10. The tie down system according to claim 5, further comprising:
a rear hitch tie down assembly pivotally attached to the support surface behind the at least one base; and
a control rod pivotally connected between the rear hitch tie down assembly and the support bar, wherein when the support bar is in a loading position, the rear hitch tie down assembly is in a low profile position that the vehicle can drive over, and movement of the support bar into a locking position, causes the rear hitch tie down assembly to pivot into an upright position readied for a user to attach the hitch tie down to a hitch to further secure the vehicle to the support surface.

11. The tie down system according to claim 10, wherein the rear hitch tie down assembly comprises interconnected pivoting U shaped members that can be pivoted into an extended position, placed over a hitch ball of a vehicle, and then pivoted into a locked position on the hitch ball.

12. The tie down system according to claim 11, wherein at least one tab is disposed on an intermediate one of the interconnected pivoting U shaped members to prevent it from folding back beyond parallel alignment with a base one of the interconnected pivoting U shaped members as a user pivot latches the assembly over the ball hitch.

13. The tie down system according to claim 11, wherein the rear hitch tie down assembly being pivotally attached to the support surface further comprises:
an attachment tube being attached to the support surface;
a base one of the interconnected pivoting U shaped members having a bottom portion shape corresponding to the shape of the attachment tube; and
the bottom portion being rotatably disposed inside the attachment tube.

14. The tie down system according to claim 1, wherein the clamp further comprises:
parallely aligned clamp housing plates;
each of the plates having a recessed anterior portion through which a latching member is allowed to protrude;
the latching member having a generally arcuate Y shape with anterior bifurcated claws and a posterior clamp stop boss to limit displacement of the claws;
the latching member being rotatably attached between the housing members;
a spring attachment bore being disposed on the latching member so that the latching member may be normally biased in an open position by a spring attached to the bore;
a release lever being in operable contact with a portion of the latching member;
the release lever having a spring attachment point for remaining end of the spring attached to the latching member;
the release lever being pivotally attached to the housing and having a latch locking detent; and
wherein as the portion of the recreational vehicle to be held/tied down engages the latch claws a portion of the latch rotates toward the latch locking detent until said portion of the latch and the locking detent engage each other, the spring bias in the release lever causing the detent to securely lock the clamp claws around the portion of the vehicle caught between the claws.

15. The tie down system according to claim 14, wherein movement of the release lever which a user causes in a direction opposite the spring bias allows the portion of the latch in contact with the locking detent to clear the locking detent to permit the spring biased claws to rotate into the unlock position.
